(19) United States
(12) Patent Application Publication
(10) Pub. No.: US 2002/0046040 A1
(43) Pub. Date: Apr. 18, 2002

(54) Information and communication system

(76) Inventor: Markus Kirner, Heilbronn (DE)

Correspondence Address: Jordan and Hamburg LLP, 122 East 42nd Street, New York, NY, 10168, US

(21) Appl. No.: 09/817,444

(22) Filed: Mar. 26, 2001

(30) Foreign Application Priority Data
Apr. 5, 2000 (DE) 100 17 033.1-53

(51) Int. Cl. G06F 17/60

(52) U.S. Cl. 705/1

(57) ABSTRACT

An Internet-based information and communication system with at least one computer functioning as central server, wherein the system comprises information carriers, which can be distributed by at least one users to certain persons, each information carrier having a carrier-specific access code, through the input of which on an external computer on a central access page made available by the central server, a code-specific information page, which is assigned to the access code, can be assembled by the user and expanded by the input of a different access code by hyperlinks assigned to the latter, can be called.

The invention relates to an Internet-based information and communication system with at least one computer functioning a central server.

Many companies use the Internet in order to provide information in this manner about their products and services. The information possibilities of the Internet are used by consumers before a purchasing decision is made by selectively selecting home pages of different companies and downloading information.

In practice, however, it frequently happens that the exact domain address of a company is not known. In view of the explosively increasing number of domain names in the Internet, it is also not possible every company to use its company name as Internet domain. Admittedly, it is possible to search for an unknown domain using search engines. However, this method is uncertain and possibly tedious, if the company in question has not been entered in the data base of the search engine. This circumstance is particularly unwelcome for the consumer, since searching for offers of interest to him is cumbersome and laborious. On the other hand, a company, advertising in the Internet, must fear that its home page will not be found and that the consumer will buy it from a competitor.

It is therefore an object of the invention to make it easier to find information in the Internet.

To solve this problem, provisions are made pursuant to the invention in the case of an information and communication system of the type named above, that the system comprises information carriers, which can be distributed by at least one issuer to certain persons, each information carrier having a carrier-specific access code, through the input of which on an external computer on a central access page made available by the central server, a code-specific information page, which is assigned to the access code, can be assembled by the user and expanded by the input of a different access code by hyperlinks assigned to the latter, can be called.

The information carrier represents the connection between the interested persons or consumers address and the information of a company, which distributes the information carrier to selected persons. For this purpose, it contains all instructions required for finding the information in the Internet. By using a carrier-specific access code, it is ensured that only authorized persons can obtain access to the information. Personalized information can be made available, in that the information is coordinated with personal interests. Basically, however, the cards are not personalized when distributed, that is, they are distributed anonymously. Only if the card user so desires, he can transmit his personal data to the card issuer. The information page can be accessed from any communication device connected with the Internet, for example, from a PC. The person selects a certain, central access page and arrives at the Internet page of the operator of the information and communication system. Further information can be retrieved from there.

In the case of an inventive information and communication system, the information carrier preferably is formed like a check verification card, on which the Internet address of the central access page and the access code are printed. Plastic cards, in the form of a check verification card, are preferred. A card on cardboard or the like is also conceivable. Such plastic cards are data and advertising carriers, which are accepted by the market, and produce a particularly bonding effect to a certain product or company. The check verification card can be kept conveniently by the consumer together with his remaining cards, so that he has no problems with finding the Internet address in case of need. All the necessary information is on the card. The Internet address of a central access page serves as an entry page, on which the carrier specific access code must be entered. The inventive information and communication system is developed so that the plastic cards can be issued by different companies. For example, a person may receive a card from a mail order company and a further card from a sporting goods manufacturer. For both cards, the process of logging on is identical on that the access code is entered on the central access page. The information, offered after the access page, can be selected to be specific for a company, that is, the mail order company and the sporting goods manufacturer make different offerings available.

For safety reasons, provisions are made so that the access code comprises a card number and a card code. The card number serves for specifically identifying the user, in that each card number is issued only once. The card code has the function of a personal identification number (PIN) in order to prevent improper use. In the case of the inventive information and communication system, the server has means for comparing the access code entered with an access code stored in a data base of the server and, in the event that the two codes are identical, makes access possible. The individual access code is generated by a random generator at the time that the card is produced and makes access available only to authorized users.

Inventive information and communication systems, for which the card code consists of a combination of numbers and/or letters, are particularly safe. By these means, sufficient possible combinations are made available in order to guarantee the safety of the system.

It has proven to particularly advantageous that the card number consists of at least six digits and preferably of eight digits and that the card code has at least four digits and preferably five digits. Consecutive card numbers are used, each number being issued only once. The card numbers can also be any combination of the numbers 0 to 9 and/or the letters A to Z. After the card number and card code have been entered, the data entered is checked with the data stored in a data base of the server. In the case of agreement, access is granted to an individual card page. The contents of this code-specific information page is determined by the respective card-issuing company. It is also conceivable that a company will have several different product areas and issue different cards accordingly, which are distributed among the consumers addressed. The cards can either be distributed widely, for example, over advertisements in magazines or handed over personally. On the other hand, handing over the cards personally enables the issuer to hand over his card selectively, so that he knows which card a customer has received. With that, it is possible to use individual employees as personal and competent on-line advisors. For example, the cards are issued in individual departments of a department store. Accordingly, the customer receives his card from a customer consultant from a particular sales department and also finds this consultant on-line as a personal consultant.

In a further development of the invention, provisions are made in the case of an inventive information and communication system so that the code-specific information page has one or more hyperlinks, which are linked with Internet pages of the card issuer. After a hyperlink is called, the user reaches either the general home page of the card issuer or an Internet page of the card issuer, designed especially for the information and communication system. Alternatively, the hyperlinks can also be linked with information pages of other suppliers, for example, with those of product manufacturers, on which the user finds the desired information. By using hyperlinks, the cumbersome manual entry of the Internet address becomes unnecessary. It is very simple and convenient for the user to find information. At little cost, the card-issuing company achieves the desired advertising effect and can target potential customers.

It is particularly advantageous for the user that the code-specific information page can be expanded by this assigned hyperlink by entering an access code of a different card issuer. If the user receives a card from a first card-issuing company, he has access to the information offered by this company. If, at a later time, he receives a further card from a different company, he can make use of the information offered by both offerers, in that he combines the new card with the old. The user initially logs on with the access code of the first plastic card; subsequently, he can combine his active card with a further card of his choice, in that he enters the card number and the card code of the second card. The next access can be gained either with the access code of the first or that of the second card. The information page, which then appears, is the same in both places. The code-specific information page is now expanded by the information of the second card issuer. In this way, the user can freely configure the extent and appearance of his code-specific personal information page according to his fields of interest on the basis of the cards obtained. If several cards are combined, the information and communication system becomes a central purchasing and information platform for the user, since he reliably finds the information sought in spite of the enormously large flood on data of the Internet. The card acts as an “information filter” and makes a pre-selection from the total offerings possible, only the information, desired by the user, and coordinated with his personal information requirements, being passed on.

An inventive information and communication system, which has means for sending and receiving electronic communications over the information page, is particularly user friendly. The exchange of e-mails takes place primarily between the card issuer and the card user, e-mails being exchanged on-line. E-mails are exchanged between the user-specific information page of the card user and the associated on-line mail folder of the card issuer. It is also conceivable that the card issuer does not reply to inquiries himself, but leaves these tasks to appointed persons or service companies which work as a call center. The card user can ask selective questions concerning certain products over the computer, the questions being answered personally by an employee of the card issuer, so that a further possible contact is made available to the consumer. A card user can also turn to the operator of the information and communication system by e-mail and request service or help from the operator. Aside from the use of e-mails as system-internal communication means, these can also be used for sending and receiving external communications, as a result of which there are additional advertising possibilities. The operator of the information and communication system can attach his own advertising text, for example, to the e-mails of the user, in order to gain additional customers and to publicize the system. However, memory-intensive information is not sent as an e-mail attachment, instead, it is transmitted by hyperlinks integrated in the text of the e-mail.

The card issuer has a special card, which enables him to have general access to his own offering of information. He can read and send an e-mail and change the look, the contents and the associated links of his information pages.

It is also conceivable that the operator of the information and communication system functions as Internet provider, the costs being met by the users as well as by the advertising, card-issuing companies. The customer is charged either a flat rate or a fee depending on the time used. The former possibility is particularly attractive for the card-issuing company, since all Internet activities of a user can be brought into conjunction with the advertising company over the card.

An information and communication system is preferred, for which an electronic communication contains hyperlinks, through the selection of which context-specific information and/or help pages can be called. It happens frequently that many consumers raise the same questions, for example, concerning the price of a new product whether it can be delivered or when it will appear on the market. After a sale, there are questions concerning the use and handling or the warranty. The handling of these questions can be standardized, in that the response communications, sent as e-mails, contain hyperlinks, which answer the questions posed. Individual replies to questions, which consume much time, can be omitted or, at the very least, greatly simplified; this consequently results in shorter handling times and reductions in costs. The hyperlinks lead to certain Internet pages of the card issuer, on which the user will find the information sought. The Internet pages can also be linked together in tree-like fashion, a selection from several alternatives being offered on each page, so that the user can find the information sought stepwise.

Provisions can also made so that the plastic card optionally additionally contains a memory, preferably a magnetic strip or a chip, in which the card number and/or the card code and/or user-specific data are stored. When the card is inserted in a card reader of a communication device connected with the Internet, the access code is transmitted automatically and the information page, assigned to the access code, is called. With that, the use of the card is simplified appreciably, since the manual input of the access code is omitted. The card can also be used by the user on the road wherever an appropriate card reader is available.

In accordance with a second solution of the problem, on which the invention is based, provisions are made for an information and communication system of the type named above, so that it comprises codes, which can be issued by at least one issuer and transmitted by a user over a communication connection to the central server, it being possible, after the transmission, to call a code-specific information page in the Internet, which can be assembled by the user, linked over a hyperlink with the information assigned to the code and expanded by the entry of a different code by a hyperlink, assigned to this code.

The function of a code of this second solution differs from that of an access code of the first solution. Each access code is unique and is printed only a single information carrier. It can therefore be assigned to a particular user and can serve as an identification characteristic. Only the owner of the information carrier or of the card knows the access code consisting of the card number and a card code. Admittedly, the personal data of the user are not necessarily known to the system operator. However, the latter, by means of the combined access codes, can draw conclusions concerning the preferences of the user, that is, concerning the companies preferred by him or to his fields of interest. On the one hand, the access code can be used as an authorization check and, on the other, it enables the information, made available by the issuer, to be requested.

In contrast to this, a code of the second solution is not issued just once, but is widespread, so that the same code can be used by a large number of users.

Each code is linked to certain information, which is fixed by the issuer and be requested after the user has entered in the code. In the simplest form, it may be information about the address of the home page of the issuer. After the code is entered in and the information requested, a user reaches the home page of the issuer and can obtain information there concerning products and services. A code may also be linked directly with certain information about a product or a service, so that the user may request special information related to the offering. An issuer can issue many different codes, which relate to different offerings. The user can combine the information from several codes on the code-specific information page. For example, he can store different offerings from the same supplier. However, by putting in the appropriate code, the user can also contrast and compare products from competitors directly with one another.

The code is made known by the issuer to as many potentially interested persons as possible, so that it cannot be used to identify a particular user of the information and communication system.

The input of the code is particularly user friendly, when the communication connection is in the form of a mobile phone connection and/or an Internet connection. A mobile phone connection has the advantage that a user can transmit a code to the computer practically at any time. The input can therefore be made anywhere and is independent of stationary input devices. In this way, several codes can be entered consecutively, the associated information being requested subsequently over the Internet. Alternatively to transmitting the code over a mobile phone connection, the user can also transmit new codes over the Internet to the central server.

Communication connections, for which an identification, identifying the user, is transmitted automatically to the computer, are preferred. If an automatic transmission is not possible, the identification can be entered manually by the user.

Advisably, the identification, identifying the user, is a call number, which preferably is the call number of a mobile telephone, which is transmitted automatically when the connection is established. However, the call number can also be that of a fixed network connection, provided that this can be transmitted automatically to the computer. The automatically transmitted identification can serve as an access code, since it cannot be affected by the user. Especially mobile telephones usually are used by a single person, who can be identified by the call number transmitted. If communication is established over the Internet, an access code or a confidential number can alternatively be used as identification. The user receives this identification after signing on by e-mail.

If the first contact is made over the mobile telephone, his cellular phone number is recognized automatically and he can enter the first code. The code for access to the Internet is forwarded to him as a short message service (SMS) communication. Further codes can be entered by the user over the Internet as well as over the cellular phone.

In the case of a communication connection established over a mobile phone, the code advisably is entered manually by the user over a keyboard or acoustically and transmitted to the computer. The code can be entered particularly conveniently and reliably over a barcode reader of a mobile phone. This barcode can be disseminated by the system operator alternatively or in addition to a printed code. The user can read the code with the barcode reader over the mobile phone and subsequently transmit it automatically.

So that the user can be certain that the code, newly entered, has been recorded correctly by the system, a speech communication can be transmitted to the user immediately after the code has been entered. Likewise, provisions can be made so that the user receives an SMS communication.

For the widest possible dissemination, a code advisably is a component of advertising media. In this connection, basically all advertising media are conceivable. They can be in the form of plastic cards or stickers or of an imprint on the goods or the product packaging. Likewise, the advertising medium may be an Internet banner, an advertising e-mail or an advertising SMS. In the case of Internet banners, provisions can be made so that, when these are clicked, the personal information page of the user is taken over automatically. The Internet pages offered by different suppliers may have a logo of the system supplier, which is in the form of a hyperlink or banner and, if of interest, clicked by the user. After the code is transmitted, the user sees on his personal page who the supplier is. Optionally, reference can also be made directly to a special product linked with the code, so that direct contact between the user and the supplier can be established over the system. In a further development of the system, provisions can be made, so that the user can order the product over the Internet. The operator of the information and communication system, as middleman between the suppliers and the users, can also handle the order and process the shipping and payment. It is also possible that payments are made over a mobile telephone payment system.

Posters, television and radio spots, as well as advertisements in newspapers, magazines and trade journals come into consideration as advertising media. Goods, displayed in shop windows, can also be provided with codes. Likewise, flyers or inserts are suitable. In a further development of the invention, provisions are made so that exhibits at a trade fair can also be provide with codes, so that visitors can request special information. Advertising media in printed form may also contain bar codes, which are read with a bar code reader of a mobile telephone.

For both variations of the inventive information and communication system, the code-specific information page may contain communications from an issuer to the user. These can be, for example, in the form of e-mails, that is, the user initially sees the title line or the heading of the communication and can click on this in order to obtain detailed information. In this way, the issuer can regularly address those users selectively, who have expressed an interest for his products. In this way, dissemination losses can be minimized and the advertising budget can be used goal-directed.

In a further development of the inventive system, provisions can be made so that code-specific information page has hyperlinks, which are linked with Internet pages of the issuer. By clicking the hyperlink, the user arrives at a homepage of the respective issuer and can obtain more detailed information there about the goods offered. With that, a direct contact between the supplier and the user can be established over the system. Likewise, he can contact the consultants of the issuer, so that he can receive advice personally over the Internet. For this purpose, means, in the form of an e-mail function, advisably are provided on the information page for sending and receiving electronic communications. Likewise, context specific information or help pages can be called over the hyperlinks, in order to take into account the information requirements of the customers. These Internet pages may also contain the answers to frequently posed questions, in order to remove the burden from the comparatively cost-intensive hotline.

In the case of the inventive information and communication system, it is particularly important that all contents of the information page can be grouped, expanded and deleted once again by the user. Accordingly, the user can set up an Internet environment as desired and he can thus retain control over the offers presented to him. Moreover, the issuer or operator of the information and communication system receives only that data of the user, which the latter voluntarily discloses. If a user wishes to remain anonymous, he can use all contents without revealing personal data.

To increase customer bonding and as a further inducement for use, provisions can be made so that a points account is assigned to each user and that points are issued depending on the actions of the user. The user receives points for entering a new code. Moreover, points are given for selecting hyperlinks. If a user reads communications from an issuer or makes contact with a supplier by e-mail, the points account of the user is also increased. Provisions are also made so that the user receives points for recommending the system to acquaintances. High customer bonding is achieved if the point credits collected can be paid out as a monetary amount.

Several paths are available to the supplier for communicating with the user. On the one hand, the issuer can send communications over the information page to the user. The communications are sent as e-mailss. If the user so desires, he can also receive the communications as SMS or by regular mail. The type of communication, preferred by the customer is of decisive importance in this connection. The same communication paths are available to the user for contacting with the supplier.

The inventive information and communication system is designed for using the latest communication technology. Accordingly, provisions are made so that the user also communicates with the computer, serving as central server, using the WAP-and/or GPRS and/or UMTS technology.

A further advantage for the inventive information and communication system arises when the contents of the information page, assigned to the access code, can be grouped, expanded and deleted once again with respect to the user. The contents can be combined freely according to areas of interest, so that, for example, several suppliers of the same product group can be combined on one page. The possibility therefore arises of combining several suppliers of a product category. For example, three different vehicle manufacturers can be represented jointly on one page. Subsequently, if the user receives a card from a fourth vehicle manufacturer, the proposals of this supplier can be added to the information page. If a company no longer is to be considered when making a purchasing decision, the information of this supplier can be deleted from the common page, so that it no longer appears.

Two examples of the invention are explained by means of the attached Figures. The Figures are diagrammatic representations and

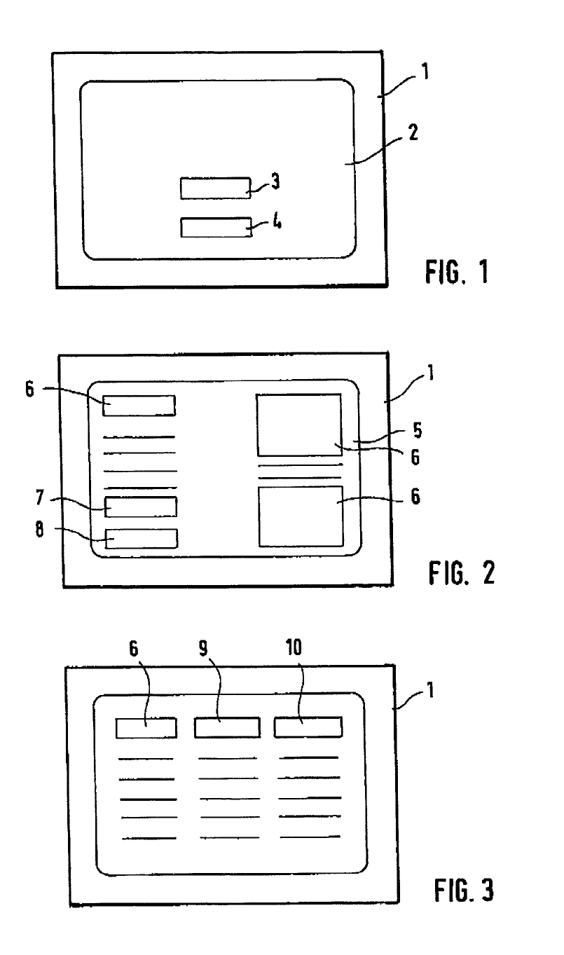

FIG. 1 shows a screen representation of the central access side page of the inventive information and communication system,

FIG. 2 shows the code-specific information page when logging in for the first time,

FIG. 3 shows an information page, put together by the user, with contents of several card issuers in accordance with the first example,

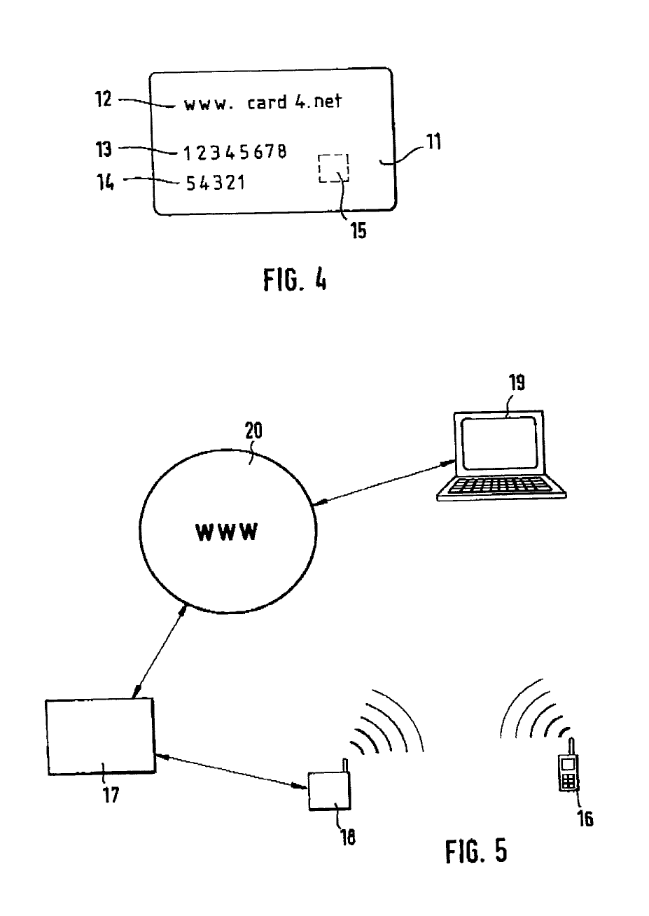

FIG. 4 shows a plastic card, issued by a card issuer, with an imprinted access code,

FIG. 5 shows a diagrammatic representation of the communication between the user and the computer in accordance with the second example and

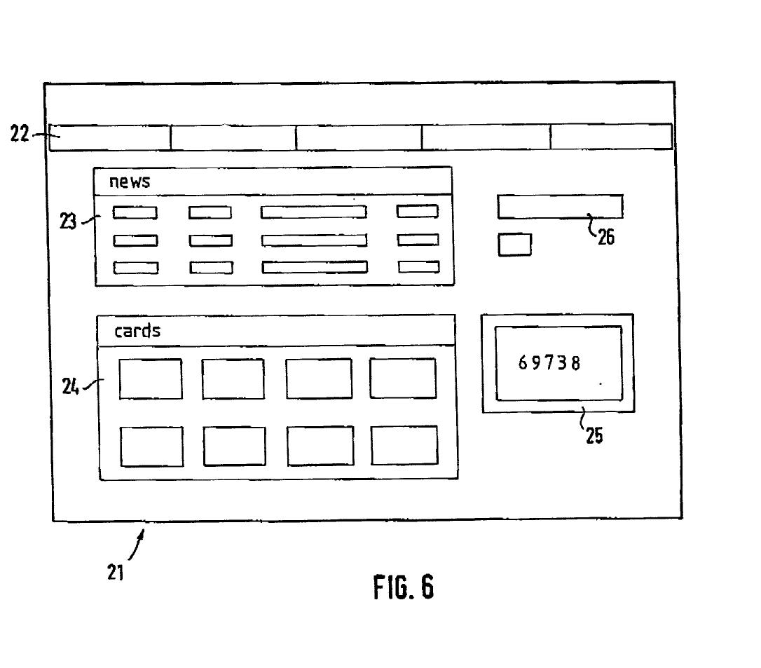

FIG. 6 shows a screen representation of an information page, put together by the user, in accordance with the second example.

As information carrier of the information and communication system, the card 11, which is shown in FIG. 4 and similar to a check verification card, is used. The user obtains the card 11 from a company, which wants to draw attention with it to its offerings, which can be requested from the Internet. The card 11 may have been distributed, for example, by a mail order company. As can be seen in FIG. 4, different information is printed or imprinted on the card 11 and makes it possible to find Internet information. In the first line, the Internet address 12 of the operator of the information and communication system is given and, in the example shown, reads www.card4.net. A central access page 2, which is called whenever the card is used, is reached over this address.

If the user enters the Internet address 12 in a browser program of a PC, which is connected with the Internet, the central access page 2, which is pictured in FIG. 1, appears on a screen 1. In this connection, it does not matter whether the user is using the card 11 for the first time or whether he has used the information offered already frequently, because the screen representation of the central access page is always the same.

The access page 2 contains two input fields 3, 4 for entering the access code. Aside from the Internet address 12 of the central access page, there is a card number 13 as well as a card code 14 on the card 11 shown in FIG. 4. In this case, the card number 13 is an eight-digit number and the card code 14 is a five-digit number. Each card number 13 is issued only once and is therefore individual. The card code 14 is printed on the card 11. Since the card code 14 has the function of a PIN number, it can also be supplied to the user separately for safety reasons, so that an improper use by third parties is prevented. In addition, the card code can be changed by the user. The card 11 furthermore has an electronic memory in the form of a chip 15, which can be read by a reader.

In order to obtain access to the information and communication system, the card number 13 is entered into the upper input field 3 and the card code 14 in the lower input field 4. The data entered is transmitted over the Internet to a computer, which functions as a central server and is also a component of the information and communication system. The central server contains a data base with all card numbers and the associated card codes, as well as further user-specific information. The data entered is compared with the data stored in the data base. If they are identical, access is released and, when logging on for the first time, the information page 5, shown in FIG. 2, appears on the screen 1. In the case of this example, the information page 5 refers to the Internet offerings of a mail order company.

As can be inferred from the representation in FIG. 2, the information page contains various information, such as information made available by the operator of the information and communication system, as well as information from the card-issuing company, which is presented in the form of text, images, hyperlinks and other multimedia components 6. In the right column of the screen representation of the information page 5, there are two images 6, which are disposed one beneath the other and refer to a special offering. The images are formed as hyperlinks and, when selected, call up further information pages, which provide more detailed information concerning the products in question. In the left column, the user finds general information concerning the company and the ordering possibilities. Information concerning, for example, the possibilities of supplying individual products, warranty conditions and exchange and return conditions can be requested. Information in the form of three-dimensional views, which can be rotated by the user and make it possible to view a product from several sides, have a high informational content. If the user has already placed an order over the Internet, the actual status of the order can be requested at any time. Likewise, the grand total of the purchases made can be indicated. An additional inducement is provided by the possibility of participating in a prize drawing.

Over the switch area 7, an e-mail function is selected, by means of which the user selectively can contact a consultant of the card issuer. After the switch area 7 is selected, a further window or a new screen section appears, which contains the personal card mail folder of the user with the e-mails received and sent. In this way, the user can pose questions concerning products or their use and the company has the possibility of advising him specifically. Information is exchanged by e-mails, which may also contain information concerning present special offers or actions of the supplier. The user can communicate by e-mail with the operator of the information and communication system, who can also inform him of new suppliers within the system. Furthermore, e-mails can also be sent to external addresses. The high advertising effect of the system is increased, in that advertising messages are appended to the individual e-mails, in order to obtain further users. By these means, the information from the supplying companies is transmitted to a continuously increasing number of interested persons in the course of time, without any increase in cost to the supplier.

In the case of a different embodiment of the information and communication system, the access code consisting of the card number 13 and the card code 14, are entered and a special information page of the supplier is called up directly and archived on his server. For example, the supplier can distribute cards relating to a trade fair or a special event. If a consumer subsequently uses this card, special subject-related offers can be submitted to him. This special information page will lead him then to other offers on the home page of the company.

When dialing up the switch area 8 in FIG. 2, a function is called up, with which the active card 11 can be combined with a further card. For this purpose, it is necessary to enter the card number and the card code of the second card. Each time that the user receives a new card from a card issuer, he is able to combine the information offered by the company in this way with the information already present. The number of combinable cards is unlimited; any number of cards can be combined. The user can selectively put together the companies preferred by him, in order effortlessly to find the offers of interest to him. For example, he can combine the information of the card issuer of the first card 11 with that of a mobile telephone supplier and with the offers of a preferred car rental company, provided that he has received appropriate cards from the respective companies. By entering any access code, access is produced through the offers of all the suppliers combined. The card is therefore geared to the personal information requirements of the user, who is automatically protected against bothersome information from other suppliers. In the course of time, a personal mail folder is developed with an unlimited of diversified contents.

FIG. 3 shows an information page, which has been put together by the user and contains information from three different companies. In addition to the information 6 from the mail order company, which was the only one to appear when a card was used for the first time, offers of a mobile telephone supplier 9 as well as a car rental company 10 can be requested. The user has received a plastic card from all three companies and combines the cards with one another. Altogether, he has three different access codes, with which he can establish access to the information page shown in FIG. 3. As can be seen there, each column is assigned to one of the suppliers and contains hyperlinks, which lead to further information pages. If the user receives further cards, he can combine the additional offers with those already present. For reasons of space, the screen area, available for each supplier is limited, so that, to begin with, only the company name and associated company logo are shown. This information is in the form of a hyperlink and, when selected, leads to special information pages of each individual supplier with detailed information.

The desired information can be put together freely and grouped by the user. Individual suppliers can be deleted once again when their offerings are no longer of interest. In the preliminary stages of a purchasing decision, the user can combine several suppliers of a category, in order to compare the individual offerings selectively. For example, three electrical markets can be combined on one page, in order to be informed at all times about price reductions and special offers.

Taking into consideration the data protection law, the pages, selected by the user, can be evaluated statistically in order to obtain user profiles. In general, personal data of a user are not known, because the cards are distributed anonymously. Only should he so desire, can he transmit his personal data to the card issuer. The user profiles can be used as a basis for advertising messages, which are matched to the information and purchasing behavior. To a purchaser of sporting goods, for example, offers concerning specialized books in his field of interest or sport travel can be made on the occasion of his next visit. A much higher advertising success can be achieved by selectively addressing target groups.

The operator of the information and communication system can determine, judge and evaluate the whole information and purchasing behavior of a user. On the basis of the user profile, so produced, the operator can function as middleman for other companies, so that suppliers and users are selectively brought together.

Conversely, the possibility exists of inquiring into the satisfaction of the customer with individual suppliers with regard to price, quality, service, etc. in order to obtain a guide for improving the offering, in that the product is evaluated after a purchase and after it has been used.

The inventive information and communication system can also be used between companies in the so-called “business-to-business” area. Product catalogs are made available in the Internet for specialists without the need for high printing costs. In addition, the information is always up to date. It is also possible to offer different price and delivery conditions to different customers and to limit the circle of receivers of confidential information.

A further example is explained by means of FIG. 5. FIG. 5 is a diagrammatic representation of the communication between the user and the operator of the information and communication system. Codes are issued by different advertising media by an issuer. They can also be exhibited on posters; likewise, they can be shown in advertisements in a magazine or a newspaper. In addition, the codes can also be disseminated and in electronic form, for example, as SMS news or as e-mail. The codes are disseminated widely, that is, the same code is used by a large number of users. A particular code can be issued, for example, by a subsidiary of a company, so that the resonance on the advertising can be determined selectively.

For example, if a user sees a code in a display window, he can transmit this code directly over his mobile telephone to the operator of the information and communication system. The code preferably is a sequence of numbers; alternatively, an alphanumeric symbol chain can also be selected as code. In order to transmit this code to the operator of the information and communication system, a communication connection is established by the user with a central server. For this purpose, he dials a particular access number of the system operator using his mobile phone 16, in order to make the transmission of the data possible. During the connection by mobile phone, the dial-up number of the cellular phone 16 is transmitted automatically to the computer 17. From the cellular phone 16, the data is transmitted in wireless fashion to the base station 18, from where it is passed on over the telephone network to the computer 17, which functions as the central server. The user is requested to enter the code and can enter the new code over the keys of the mobile phone 16. Provisions can also be made so that the user transmits the code as a voice communication and that the computer 17 has an appropriate voice input system, which converts this voice communication into data. Subsequently, the user receives confirmation of the input of the code from the computer 17. For each code entered, the user receives points, which are added to a personal points account; the points are given out depending on the actions of the user, for example, for each contact by e-mail, for recommending the system to others or for selecting hyperlinks. The points correspond to a certain amount of money and, when they reach a certain level, can be paid out. Alternatively to a monetary award, the user also has the choice of different goods. An award can also be used to add funds to a credit card for a mobile phone or to surf the Internet at no cost.

In order to be able to access the information, the user must establish a communication connection over the Internet with the system operator. This can be done preferably over a personal computer, which can be connected with the Internet. Likewise, mobile communication devices are suitable for this purpose. As shown diagrammatically in FIG. 5, communication between the user and the computer 17 is established over a computer 19, which is connected to the Internet 20 in the usual manner. After communication has been established, the user can communicate directly with the computer 17 of the system operator.

In a browser program of the PC 19, the user selects the Internet address of the information and communication system and is requested to enter the cellular phone number and his user password. The cellular phone number identifies a particular user, since it is a number, which is issued only once. When he uses the system for the first time, a user receives the password, which can be forwarded to him as e-mail or as an SMS message.

FIG. 6 shows the personal information page 21 of the user, which appears on the screen when he logs on. In the upper region of the information page, there is a menu strip 22 with switch areas, through the selection of which further menu screens can be called up. The user enters the new code in the input field 26 and forwards it on-line to the system operator. As can be inferred from the screen display, the user has already entered a number of codes, one of the hyperlinks, shown as an outline in field 24 of FIG. 6, being assigned to each code. Each hyperlink contains a logo of the respective supplier, so that the information of a particular company can easily be found. After a new code has been entered, the associated hyperlink is displayed in field 24 and can be clicked. At a later time, if the information from a particular supplier no longer is wanted, the corresponding hyperlink can be deleted once again by the user. On a separate menu, the user can selected those companies, from whom he would like to obtain information in the future and which correspond to his personal interests. For this purpose, it is not necessary to know the code issued by the company. In addition, he can select whether information shall also be sent to him by e-mail, as SMS or by regular mail. Should he no longer be interested in one of the offerings, he can delete the company in question again at any time from his personal list. He therefore receives only the information, which he himself has requested. If he has questions concerning individual products or the use of a product already purchased, he can contact the appropriate supplier over an e-mail function.

In an upper field 23 of the information page 21 of FIG. 6, further hyperlinks are displayed, which can be called by the user. Each line relates to a hyperlink, of which a slogan-like title, the appearance date and such further information can be seen as, for example, whether the information linked to it has already been called. In addition, the point number is given, which the user receives by requesting the hyperlink. The present total point count of the user is shown in field 25 of the information page 21 and brought up to date immediately after the user has carried out actions, for which points are awarded.

The user can select whether he will transmit a new code to the system operator over his mobile phone or over a PC. Basically, both possibilities are available to him, an entry over the mobile phone having the advantage that the user can immediately enter a code, which he sees on a poster, wall or in a display window, and transfer it, without having to remember or make a note of a number. If he decides to enter the code on a personal computer, he can have direct access to the information linked to the code.

The information and communication system is free charge for the user. The system operator charges a fee to the offering companies, depending on the nature and the amount of the information requested.

1. An Internet-based information and communication system with at least one computer functioning as central server, wherein the system comprises information carriers, which can be distributed by at least one users to certain persons, each information carrier having a carrier-specific access code, through the input of which on an external computer on a central access page made available by the central server, a code-specific information page, which is assigned to the access code, can be assembled by the user and expanded by the input of a different access code by hyperlinks assigned to the latter, can be called.

2. The information and communication system of claim 1, wherein the information carrier is in the form of a card (11), especially of a plastic card, preferably in the check verification card format, on which the Internet address (12) of the central access page (2) and the access code are printed.

3. The information and communication system of claim 1 or 2, wherein an access code comprises a card number (13) and a card code (14).

4. The information and communication system of one of the preceding claims, wherein the server has means for comparing the access code entered with an access code stored in the data base of the server and, in the event that the two codes are identical, provides access.

5. The information and communication system of claim 3 or 4, wherein the card code (14) consists of a combination of numbers and/or letters.

6. The information and communication system of one of the claims 3 to 5, wherein the card number (13) is at least a six-digit, preferably an eight-digit number and the card code (14) is at least a four-digit and preferably a five-digit number.

7. The information and communication system of one of the claims 2 to 6, wherein the plastic card (11) optionally additionally has a memory, preferably a magnetic strip or a chip (15), in which the card number (13) and/or the card code (14) and/or user-specific data are stored.

8. The information and communication system of one of the claims 2 to 7 wherein, when the card (11) is inserted in a card reader of a communication device, connected with the Internet, the access code is transmitted and the information page and/or the user-specific survey page (5), assigned to the access code, can be requested.

9. An Internet-based information and communication system with at least one computer functioning as central server, wherein the system comprises codes, which can be issued by at least one issuer and can be transmitted by a user over a communication connection to the central server (17) and, after the transmission, a code-specific information page (21), which can be assembled by the user, can be requested in the Internet, the information page (21) being linked over a hyperlink with information assigned to the code and can be expanded by the entry of a different code by a hyperlink assigned to this code.

10. The information and communication system of claim 9, wherein the communication connection is established as a mobile phone connection and/or as an Internet connection.

11. The information and communication system of claim 9 or 10, wherein the communication connection for automatically transferring an identification, identifying the user, is established at the computer (17).

12. The information and communication system of claim 9 or 10, wherein an identification, identifying the user, can be entered by the user and transferred to the computer (17).

13. The information and communication system of claim 11 or 12, wherein the identification is formed as a call number.

14. The information and communication system of one of the claims 11 to 13, wherein the identification comprises an access password.

15. The information and communication system of claim 14, wherein the access password is transmitted to the user after the first input of the code.

16. The information and communication system of one of the claims 9 to 15, wherein the communication connection can be established over a mobile phone (16).

17. The information and communication system of claim 16, wherein the code can be entered manually and/or acoustically and/or by means of a bar code reader by the user into the mobile telephone (16).

18. The information and communication system of one of the claims 9 to 17, wherein the system is designed to transmit a confirmation to the user after a code is entered.

19. The information and communication system of claim 18, wherein the confirmation is designed as a voice notification and/or as an SMS notification.

20. The information and communication system of one of the claims 9 to 19, wherein a code is a component of an advertising medium.

21. The information and communication system of claim 20, wherein the advertising medium is a plastic card or an advertising display or a poster or a sticker or an imprint on goods.

22. The information and communication system of claim 20, wherein the advertising medium is an Internet banner or a television or radio spot or an e-mail.

23. The information and communication system of one of the preceding claims, wherein the code-specific information page (21) contains communications (23) from an issuer to the user.

24. The information and communication system of one of the preceding claims, wherein the code-specific information page (21) has hyperlinks (24), which are linked to Internet pages of the issuer.

25. The information and communication system of one of the preceding claims, wherein the system has means for sending and receiving electronic communications over the information page (21).

26. The information and communication system of claim 25, wherein an electronic communication contains hyperlinks, by the selection of which context-specific information and/or help pages can be called.

27. The information and communication system of one of the preceding claims, wherein the contents of the information page (21), assigned to the access code, can be grouped, expanded and deleted once again by the user.

28. The information and communication system of one of the preceding claims, wherein a points account (25) is assigned to the user and the points can be depending on the actions of the user.

29. The information and communication system of claim 28, wherein the point credit can be paid out as a money amount and/or as a goods bonus and/or as free minutes for making telephone calls.

30. The information and communication system of one of the preceding claims, wherein communications of an issuer can be transmitted to the user as e-mail and/or as an SMS communication and/or by regular mail.

31. The information and communication system of one of the preceding claims, wherein the communication connection between the user and the computer is designed to make use of the WAP and/or GPRS and/or UMTS technology.

32. The information and communication system of one of the preceding claims, wherein the system comprises an ordering and/or settlement of accounts and/or delivery a system.

33. The information and communication system of claim 32, wherein the accounts are settled over a mobile phone.
